(19) United States
(12) Patent Application Publication
(10) Pub. No.: US 2025/0042038 A1
(43) Pub. Date: Feb. 6, 2025

(54) ARTICULATED ROBOT ARM CONTROL DEVICE

(71) Applicant: YAMAHA HATSUDOKI KABUSHIKI KAISHA, Iwata-shi (JP)

(72) Inventor: Tsuyoshi KURODA, Shizuoka (JP)

(21) Appl. No.: 18/921,669

(22) Filed: Oct. 21, 2024

Related U.S. Application Data
(63) Continuation-in-part of application No. PCT/JP2022/018457, filed on Apr. 21, 2022.

(51) Int. Cl. B25J 9/16

(52) U.S. Cl. CPC B25J 9/1697

(57) ABSTRACT

A control device for controlling an articulated robot arm performing work on at least one target object in a work area. The control device includes an imaging device configured to capture work area images at different imaging positions; an image display that displays the captured work area images; an image processor that determines a reference imaging position that is a position of the imaging device; and a driving controller that drives an actuator of the articulated robot arm to move the imaging device. The image processor includes a specified-position-coordinate calculator that calculates coordinates corresponding to a position of each of user-specified target objects, a target detector that detects a plurality of images of the target objects, and a reference-imaging-position determiner that determines the reference imaging position based on the detected images of the target objects and the user-specified target objects.

### CROSS-REFERENCES TO RELATED APPLICATIONS

This is a continuation-in-part application of International Application No. PCT/JP2022/018457, filed on Apr. 21, 2022, the contents of which are incorporated herein by reference.

### TECHNICAL FIELD

The present teaching relates to an articulated-robot-arm-control device.

### BACKGROUND ART

Fruits such as strawberries and grapes and green-and-yellow vegetables such as asparagus and tomatoes are more delicate and easily damaged than grains such as rice and wheat, and also have higher unit prices. Such delicate and high-priced crops are harvested manually one by one to avoid damage during harvest. Therefore, as compared to, for example, grains that can be efficiently and extensively harvested using machines such as combine harvesters, harvest of the fruits and the green-and-yellow vegetables involves a greater physical burden on producers. As a result, in harvest work of the fruits, the green-and-yellow vegetables, and other crops, securing labor for the harvest work is difficult and the burden on producers tends to increase.

As apparatus for solving such problems, a harvest system using an articulated robot arm is known. In the harvest system, a work device, an image processor, and other devices for harvesting crops are mounted on the distal end of the articulated robot arm. The harvest system causes the image processor to identify the location of crops to be harvested and causes the work device to perform harvest work.

Crops are all different in shape, placed under different surrounding conditions during harvest, and so forth. Thus, the image processor cannot accurately detect crops under the influence of situations such as the shape of crops, the surrounding conditions during harvest, and the weather in the field. As apparatus for solving such problems, an articulated-robot-arm-control device that searches for crops by capturing images of a region where crops are harvested from different positions, as disclosed by Patent Document 1, for example is known.

The articulated-robot-arm-control device disclosed in Patent Document 1 includes an imaging device that captures images of a target such as crops, an image processor that detects the target from the images captured by the imaging device, a coordinate information processor that calculates coordinates of the target, and a driving controller that controls the articulated robot arm. The articulated-robot-arm-control device captures an image of a work area where crops are harvested by the imaging device at a first imaging position and detects an image of the target. Next, the articulated-robot-arm-control device calculates coordinates of the image of the target. Further, the articulated-robot-arm-control device captures an image of the work area in different imaging conditions at a second imaging position different from the first imaging position. In this manner, the articulated-robot-arm-control device can acquire an image suitable for the state of the work area and the shape of the target.

### CITATION LIST

### Patent Document

Patent Document 1: International Patent Publication No. 2021/044473

### SUMMARY OF INVENTION

### Technical Problem

The articulated-robot-arm-control device described in Patent Document 1 captures images in different conditions at the second imaging position based on the coordinates of the target detected in the image captured at the first imaging position.

To enable an articulated robot arm to efficiently perform work on a larger number of targets, a larger number of targets are preferably included in a work area where the articulated robot arm performs work on the targets. As in the articulated-robot-arm-control device described in Patent Document 1, in the case of capturing images of the work area (hereinafter referred to as “work area images”) by the imaging device and detecting images of the targets (hereinafter referred to as “target images”) in the images, it is conceivable that images of a wide range of the work area are captured by the imaging device to include target images as much as possible.

However, when a work area image is captured to include a large number of targets in the work area, the size of the target images in the work area image might be small so as to hinder the articulated-robot-arm-control device from recognizing the target images in the work area image. In view of this, in a conceivable case, to allow the target images to be recognized as much as possible in the work area image, programs or the like for operating the articulated robot arm are corrected to match an on-site situation so that the position of the imaging device that captures images of the work area is adjusted or training data of targets are modified in conformity with the on-site situation to enhance detection accuracy of the target images included in the work area image. Such pre-work is a heavy burden on operators at the site.

In view of this, a control device for controlling driving of an articulated robot arm that performs work on targets in a work area requires a configuration enabling the articulated robot arm to efficiently perform work on a larger number of targets while reducing workload on an operator.

It is therefore an object of the present teaching to provide a control device for controlling driving of an articulated robot arm that performs work on targets in a work area with a configuration enabling the articulated robot arm to efficiently perform work on a larger number of targets while reducing workload of an operator.

### Solution to Problem

An inventor of the present teaching studied a configuration enabling an articulated robot arm to efficiently perform work on a larger number of targets while reducing workload of an operator in a control device for controlling driving of the articulated robot arm that performs work on targets in a work area. Through an intensive study, the inventor arrived at the following configuration.

An articulated-robot-arm-control device according to one embodiment of the present teaching is an articulated-robot-arm-control device for controlling an articulated robot arm performing work on at least one target object in a work area, the articulated-robot-arm-control device including: an imaging device including a camera, provided at the articulated robot arm and configured to capture a plurality of work area images, each of which is an image of the work area, respectively at a plurality of imaging positions that are different from one another relative to the work area; an image display that displays the plurality of work area images captured by the imaging device; an image processor that determines a reference imaging position that is a position of the imaging device; and a driving controller that drives an actuator of the articulated robot arm, to thereby move the imaging device to the plurality of imaging positions. The image processor includes: a specified-position-coordinate calculator that, in response to an operator of the articulated-robot-arm-control device specifying each of the target objects appearing in at least one work area image of the plurality of work area images displayed by the image display, calculates a set of coordinates corresponding to a position of said each specified target object, a target detector that detects a plurality of target images, each of which is an image of one of the target objects, in the plurality of work area images, and a reference-imaging-position determiner that determines a subset of the target images in each of the plurality of work area images, each target image in the subset having at least one of the calculated sets of coordinates within a boundary thereof, determines a total number of the target images in said subset for said each work area image, and determines the reference imaging position based on the total numbers of the target images for the plurality of work area images.

The specified-position-coordinate calculator calculates coordinates of the position specified by the operator as an image of the target in the work area image captured by the imaging device in a work field. The reference-imaging-position determiner calculates the reference imaging position of the imaging device based on the number of target images in each of which the coordinates are included in an area of the target image in the target images detected by the target detector from the work area images. That is, the articulated-robot-arm-control device can obtain an imaging position at which the target images can be appropriately detected by using the number of target images recognized by the operator and detected from the work area images in the work area images reflecting on-site conditions.

Accordingly, the control device for controlling driving of the articulated robot arm that performs work on targets in the work area can be provided with a configuration enabling the articulated robot arm to efficiently perform work on a larger number of targets while reducing workload of the operator.

In another aspect, the articulated-robot-arm-control device according to the present teaching preferably has the following configuration. The reference-imaging-position determiner selects one work area image from the plurality of work area images based on the total numbers of the target images for the plurality of work area images, and sets an imaging position at which the imaging device captures the selected one work area image as the reference imaging position.

With this configuration, the articulated-robot-arm-control device can obtain an imaging position at which target images can be appropriately detected from the plurality of imaging positions of work area images by using the number of target images recognized by the operator and detected from the work area images in the work area images including on-site conditions.

Accordingly, the control device for controlling driving of the articulated robot arm that performs work on targets in the work area can be provided with a configuration enabling the articulated robot arm to efficiently perform work on a larger number of targets while reducing workload of the operator.

In another aspect, the articulated-robot-arm-control device according to the present teaching preferably has the following configuration. The reference-imaging-position determiner selects one of the work area images that has a largest total number of the target images, and sets an imaging position at which the imaging device captures the selected work area image as the reference imaging position.

The articulated-robot-arm-control device calculates, as the reference imaging position, an imaging position at which the work area image is captured, the work area image having a largest number of target images detected by the image processor in target images recognized by the operator in the work area images reflecting on-site conditions such as brightness or obstacles. Thus, the work area image captured at the reference imaging position is likely to include a larger number of target images than work area images captured at other imaging positions. In the work area image captured at the reference imaging position, the number of target images recognized by the operator is likely to be larger than work area images captured at other imaging positions. Accordingly, the articulated-robot-arm-control device performs work on targets by using the work area image captured at the reference imaging position to thereby efficiently perform work on a larger number of targets.

As a result, the control device for controlling driving of the articulated robot arm that performs work on targets in the work area can be provided with a configuration enabling the articulated robot arm to efficiently perform work on a larger number of targets while reducing workload of the operator.

In another aspect, the articulated-robot-arm-control device according to the present teaching preferably has the following configuration. The reference-imaging-position determiner selects one of the work area images that has a smallest total number of the target images, and sets an imaging position at which the imaging device captures the selected work area image as the reference imaging position.

The articulated-robot-arm-control device calculates, as the reference imaging position, an imaging position at which the work area image is captured, the work area image including a smallest number of target images undetected by the image processor in target images recognized by the operator in the work area images reflecting on-site conditions such as brightness or obstacles. Thus, in the work area image captured at the reference imaging position, the number of target images difficult to be detected by the image processor is likely to be smaller than work area images captured at other imaging positions. In addition, in the work area image captured at the reference imaging position, the possibility of reduction of misdetection of target images visually recognized by the operator is higher than work area images captured at other imaging positions. Accordingly, the articulated-robot-arm-control device performs work on targets by using the work area image captured at the reference imaging position to thereby efficiently perform work on a larger number of targets.

As a result, the control device for controlling driving of the articulated robot arm that performs work on targets in the work area can be provided with a configuration enabling the articulated robot arm to efficiently perform work on a larger number of targets while reducing workload of the operator.

In another aspect, the articulated-robot-arm-control device according to the present teaching preferably has the following configuration. The reference-imaging-position determiner obtains the reference imaging position based on a ratio between a total number of the target images detected by the target detector and the total number of the target images for each of the plurality of work area images.

The articulated-robot-arm-control device calculates the reference imaging position of the work area based on the ratio between the number of target images detected by the image processor and the number of target images recognized by the operator as targets in the work area images reflecting on-site conditions such as brightness or obstacles. Accordingly, the articulated-robot-arm-control device can set, as the reference imaging position, the imaging position at which the ratio of detecting images of targets visually recognized by the operator is higher than that in work area images captured at other imaging positions, for example.

As a result, the control device for controlling driving of the articulated robot arm that performs work on targets in the work area can be provided with a configuration enabling the articulated robot arm to efficiently perform work on a larger number of targets while reducing workload of the operator.

In another aspect, the articulated-robot-arm-control device according to the present teaching preferably has the following configuration. The driving controller moves the imaging device relative to the work area with predetermined intervals by driving the actuator to thereby position the imaging device at the plurality of imaging positions.

The articulated-robot-arm-control device changes the position of the imaging device relative to the work area with predetermined intervals and captures work area images at individual positions. The imaging range of the imaging device and size of target images vary depending on the distance to the work area.

For example, in a case where the imaging device moves toward the work area, the imaging range of the imaging device narrows, whereas images of targets included in the imaging range enlarge. That is, in the articulated-robot-arm-control device, by moving the imaging device toward the work area, the detectable number of target images by the image processor decreases, whereas the possibility of misrecognition of target images decreases.

On the other hand, in a case where the imaging device moves away from the work area, the imaging range of the imaging device enlarges, whereas images of targets included in the imaging range become small. That is, in the articulated-robot-arm-control device, by moving the imaging device away from the work area, the detectable number of target images by the image processor increases, whereas the possibility of misrecognition of target images increases.

Thus, the articulated-robot-arm-control device can obtain an optimum imaging position at which both an appropriate detection number and an appropriate recognition rate of the targets can be compatible by adjusting the distance from the work area to the imaging device.

As a result, the control device for controlling driving of the articulated robot arm that performs work on targets in the work area can be provided with a configuration enabling the articulated robot arm to efficiently perform work on a larger number of targets while reducing workload of the operator.

In another aspect, the articulated-robot-arm-control device according to the present teaching preferably has the following configuration. The imaging device includes a camera configured to capture a second plurality of work area images at the reference imaging position respectively with a plurality of different exposure times of the camera. The image processor further includes a reference-exposure-time determiner that determines a reference exposure time of the camera based on the second plurality of work area images.

The articulated-robot-arm-control device captures images of the work area under the plurality of imaging conditions with different exposure times of the camera at the reference imaging position. The articulated-robot-arm-control device determines the exposure time of the camera based on the number of target images in each of which coordinates of the target recognized by the operator are included in the area in the plurality of the captured work area images. Accordingly, the articulated-robot-arm-control device can obtain the exposure time of the camera in which the image processor can appropriately detect target images in the work area images reflecting on-site conditions such as brightness or obstacles.

As a result, the control device for controlling driving of the articulated robot arm that performs work on targets in the work area can be provided with a configuration enabling the articulated robot arm to efficiently perform work on a larger number of targets while reducing workload of the operator.

In another aspect, the articulated-robot-arm-control device according to the present teaching preferably has the following configuration. The imaging device captures a second plurality of work area images at the reference imaging position respectively with a plurality of different color tones. The image processor further includes a color tone determiner that determines a reference color tone based on the second plurality of work area images.

The articulated-robot-arm-control device captures images of the work area under the plurality of imaging conditions with different color tones of work area images at the reference imaging position. The articulated-robot-arm-control device determines the color tone of the work area image based on the number of target images in each of which coordinates of the target recognized by the operator are included in the area in the plurality of the captured work area images. Accordingly, the articulated-robot-arm-control device can obtain the color tone of the image with which the image processor can appropriately detect target images in the work area images reflecting on-site conditions such as brightness or obstacles.

As a result, the control device for controlling driving of the articulated robot arm that performs work on targets in the work area can be provided with a configuration enabling the articulated robot arm to efficiently perform work on a larger number of targets while reducing workload of the operator.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification, specify the presence of stated features, steps, operations, elements, components, and/or their equivalents but do not preclude the presence or addition of one or more other features, steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

An embodiment of an articulated-robot-arm-control device according to the present teaching will be herein described.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

### Articulated Robot Arm

An articulated robot arm herein refers to a robot arm including a plurality of joint parts coupling a plurality of links. The articulated robot arm includes a vertical articulated robot arm. Specifically, the vertical articulated robot arm is a robot arm of a serial link mechanism in which links are coupled in series by rotary joints or prismatic joints with a single degree of freedom from the proximal end to the distal end. The vertical articulated robot arm includes a plurality of joint parts.

### Target

A target herein refers to an object on which the articulated robot arm performs work in a work area. The target includes objects that can be held by the articulated robot arm, for example, fruits such as strawberries and grapes, green-and-yellow vegetables such as asparagus and tomatoes, other vegetables, other fruits, food, electric products, and parts. The work on the target includes all the types of work performed on the target, such as harvest work, holding work, moving work, processing work, and sorting work.

### Work Area

The work area herein refers to a three-dimensional area where the articulated robot arm can perform work on a target. The work area is an area equal to or narrower than a movable range of the articulated robot arm. That is, the work area is included in the movable range of the articulated robot arm. The work area may be cylindrical, prismatic columnar, spherical, a polyhedron such as a rectangular solid, a cone or a polygonal pyramid. When seen from an imaging device provided at the articulated robot arm, the work area may be a circular area, an oval area, a polygonal area, or an area at least partially enclosed by a curve. The work area may be in any shape when seen from the imaging device provide at the articulated robot arm.

### Imaging Position

An imaging position herein refers to a position at which the imaging device provided at the articulated robot arm captures an image of a work area. The imaging position may be, for example, absolute coordinates of the imaging device or a relative position relative to a work area, a target, a structure, or an object serving as a reference. The imaging position may be a position in a coordinate system of the articulated robot arm. The imaging device may be positioned at the imaging position by adjusting the position of the imaging device by the articulated robot arm.

### Reference Imaging Position

A reference imaging position herein refers to a position at which the imaging device provided at the articulated robot arm captures an image of each work area in a case where the articulated robot arm moves to perform work on targets sequentially in a plurality of work areas. The reference imaging position may be, for example, absolute coordinates of the imaging device or a relative position relative to a work area, a target, a structure, or an object serving as a reference. The reference imaging position may be a position in a coordinate system of the articulated robot arm. The reference imaging position may be at the same position in the plurality of work areas or at the same position in some of the plurality of work areas.

### Exposure Time

An exposure time herein refers to a time in which an imaging device (image sensor) of a camera is exposed to light.

### Color Tone

A color tone herein refers to a shade of color, a fine tone of color, and a degree of color.

### ADVANTAGEOUS EFFECTS OF INVENTION

One embodiment of the present teaching can provide a control device for controlling driving of an articulated robot arm that performs work on targets in a work area with a configuration enabling the articulated robot arm to efficiently perform work on a larger number of targets while reducing workload of an operator.

### BRIEF DESCRIPTION OF DRAWINGS

FIG. 1 is a view illustrating a schematic configuration of an articulated-robot-arm device according to a first embodiment of the present teaching.

FIG. 2 is a view illustrating a state where an imaging device captures images of a work area image at a plurality of imaging positions.

FIG. 3 is a view illustrating an example of a work area image captured by the imaging device at a first imaging position.

FIG. 4 is a view illustrating an example of a work area image captured by the imaging device at a second imaging position.

FIG. 5 is a view illustrating an example of a work area image captured by the imaging device at a third imaging position.

FIG. 6 is a functional block diagram illustrating a schematic configuration of an articulated-robot-arm device including an articulated-robot-arm-control device according to a second embodiment.

FIG. 7 is a view schematically illustrating a state where driving of an actuator of an articulated robot arm is controlled by using an articulated-robot-arm-control device according to a third embodiment.

FIG. 8 is a view illustrating a schematic configuration of an articulated-robot-arm device including an articulated-robot-arm-control device according to a fourth embodiment.

FIG. 9 is a view illustrating a schematic configuration of an articulated-robot-arm device including an articulated-robot-arm-control device according to a fifth embodiment.

FIG. 10 is a view illustrating a schematic configuration of the articulated-robot-arm device according to the first embodiment and an example of a work area image captured by the imaging device.

### DESCRIPTION OF EMBODIMENT

Embodiments will be described hereinafter with reference to the drawings. In the drawings, the same or corresponding parts are denoted by the same reference characters, and description thereof will not be repeated. The dimensions of components in the drawings do not strictly represent actual dimensions of the components and dimensional proportions of the components.

### First Embodiment

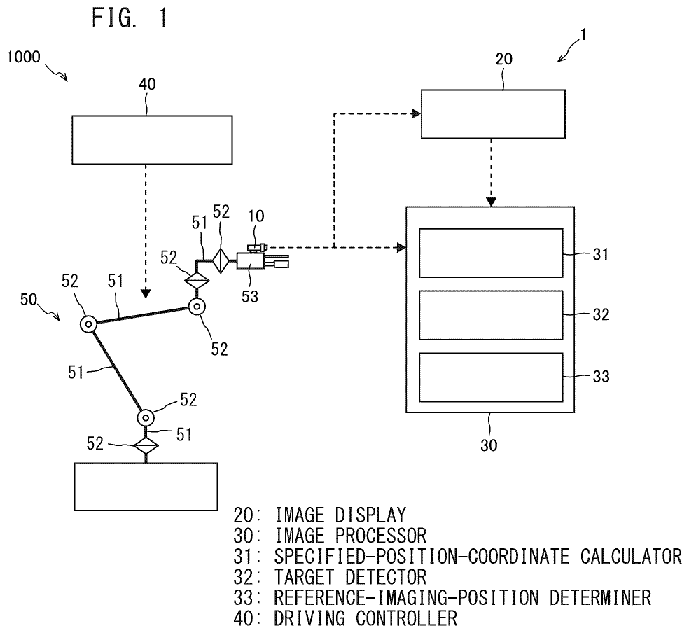

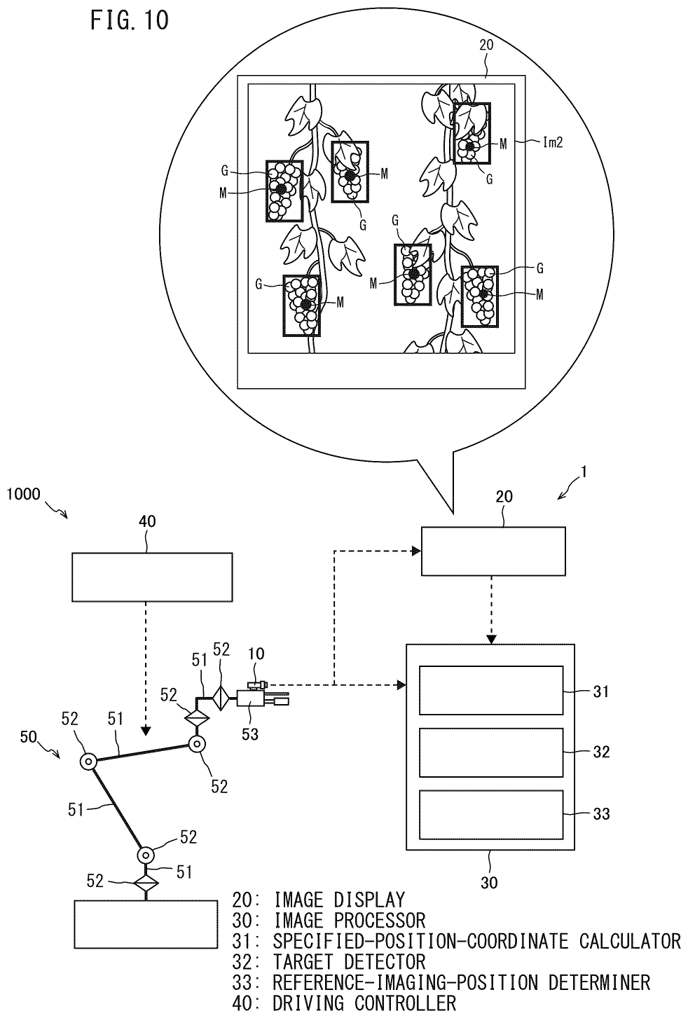

With reference to FIGS. 1 and 10, an overall configuration of an articulated-robot-arm device 1000 including an articulated robot arm 50 and an articulated-robot-arm-control device 1 according to a first embodiment of the present teaching will be described. FIG. 1 is a view illustrating a schematic configuration of the articulated-robot-arm device 1000 according to the first embodiment of the present teaching. The articulated-robot-arm device 1000 performs work on a target T in a work area W. FIG. 10 is a view illustrating a schematic configuration of the articulated-robot-arm device 1000 and an example of a work area image captured by an imaging device described later.

The target T includes objects that can be held by the articulated robot arm 50, for example, fruits such as strawberries and grapes, green-and-yellow vegetables such as asparagus and tomatoes, other vegetables, other fruits, food, electric products, and parts. The work on the target T includes all the types of work performed on the target T, such as harvest work, holding work, moving work, processing work, and sorting work.

As illustrated in FIG. 1, the articulated-robot-arm device 1000 includes the articulated robot arm 50 and the articulated-robot-arm-control device 1. The articulated robot arm 50 is mounted on, for example, a base of manufacturing apparatus, a vehicle, and so forth.

The articulated robot arm 50 includes a plurality of arms 51, a plurality of joint parts 52, and an end effector 53 including a holder and other devices. The joint parts 52 includes an unillustrated actuator for driving the arms 51. The actuator includes, for example, motors. Driving of the joint parts 52 is controlled by the articulated-robot-arm-control device 1. The end effector 53 is located at the distal end of the articulated robot arm 50 and performs work on the target T. The end effector 53 is movable relative to the target T by controlling driving of the joint parts 52 by the articulated-robot-arm-control device 1.

The articulated robot arm 50 has a configuration similar to a configuration of a general articulated robot arm. Thus, the articulated robot arm 50 will not be described in detail. The configuration of the articulated robot arm 50 is not limited to the configurations illustrated by the drawings as long as the articulated robot arm 50 can perform work on the target T.

In the articulated-robot-arm-control device 1, in performing work on the target T by the end effector 53 in the work area W, an imaging device 10 described later acquires a work area image that is an image of a work area W at a reference imaging position, and an image processor 30 described later detects a target image that is an image of the target T in the work area W from the work area image. Based on a detection result of the target image from the work area image, the articulated-robot-arm-control device 1 controls driving of the joint parts 52 and the end effector 53 of the articulated robot arm 50. In this manner, the articulated-robot-arm device 1000 performs work on the target T.

The method with which the articulated-robot-arm-control device 1 controls driving of the joint parts 52 and the end effector 53 of the articulated robot arm 50 based on the detection result of the target image from the work area image is similar to a conventional method. Thus, the method for driving control will not be described.

In performing work on the target T by the articulated robot arm 50, the articulated-robot-arm-control device 1 determines a position at which the imaging device 10 captures an image of the work area W (reference imaging position). That is, the articulated-robot-arm-control device 1 has a calibration function of adjusting the position of the imaging device 10 that captures an image of the work area W.

The articulated-robot-arm-control device 1 obtains the reference imaging position at which an image of the work area W in performing work on the target T by the end effector 53 is captured, based on the number of target images G included in a plurality of work area images Im1, Im2, and Im3. The articulated-robot-arm-control device 1 displays the work area images Im1, Im2, and Im3 at a plurality of imaging positions on an image display 20 and detects the number of target images G in the work area images Im1, Im2, and Im3, by using coordinates of a position specified by an operator as an image of the target T.

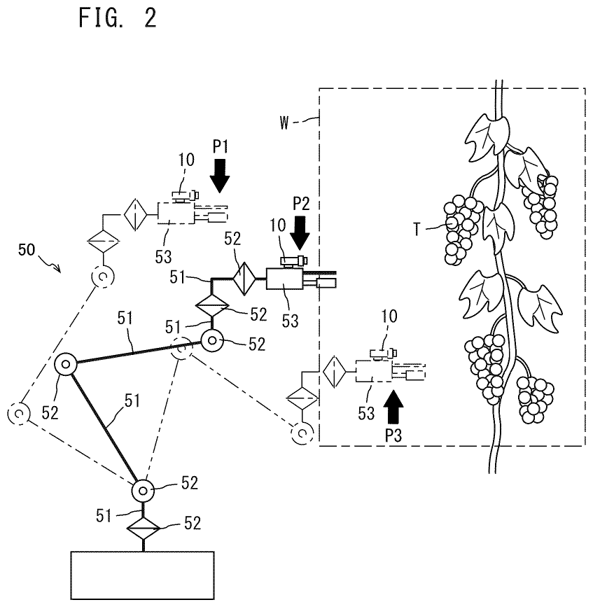

In performing calibration of the imaging positions as described above, the articulated-robot-arm-control device 1 acquires work area images at a plurality of imaging positions by the imaging device 10 describe later, as illustrated in FIG. 2. In FIG. 2, P1 indicated by an alternate-long-and-short-dash line is a first imaging position, P2 indicated by a continuous line is a second imaging position, and P3 indicated by a chain-double-dashed line is a third imaging position.

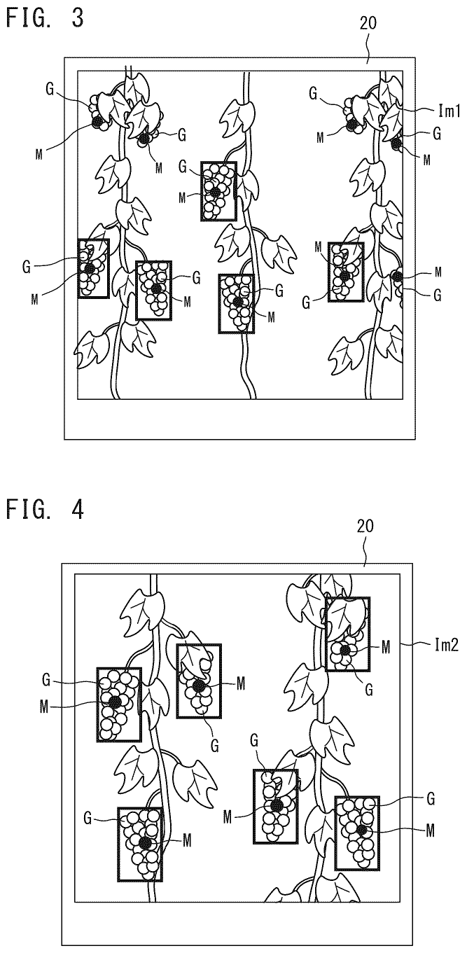

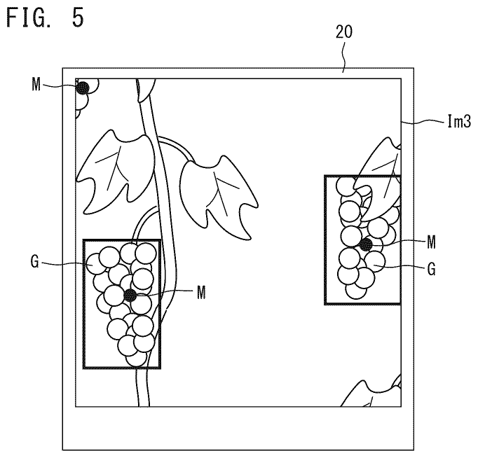

FIG. 3 illustrates an example of the work area image Im1 captured by the imaging device 10 at the first imaging position P1. FIG. 4 illustrates an example of the work area image Im2 captured by the imaging device 10 at the second imaging position P2. FIG. 5 illustrates an example of the work area image Im3 captured by the imaging device 10 at the third imaging position P3. FIGS. 3 through 5 schematically illustrate states where the work area images Im1, Im2, and Im3 are displayed on the image display 20 of the articulated-robot-arm-control device 1 described later. In FIGS. 3 and 4, character G denotes a target image that is an image of the target T.

As illustrated in FIG. 1, the articulated-robot-arm-control device 1 includes the imaging device 10, the image display 20, the image processor 30, and a driving controller 40. The imaging device 10 captures images of the work area W to acquire the work area images Im1, Im2, and Im3. The imaging device 10 is provided at the articulated robot arm 50. The work area images Im1, Im2, and Im3 acquired by the imaging device 10 are input to the image display 20 and the image processor 30. The imaging device 10 may be, for example, a stereo camera or a monocular camera. The imaging device 10 may acquire two work area images in order or may acquire four or more work area images in order.

The image display 20 has a configuration capable of displaying the work area images Im1, Im2, and Im3 acquired by the imaging device 10. The image display 20 includes a display device of a portable terminal capable of being carried by an operator, such as a liquid crystal display. The image display 20 is configured to enable input work of the displayed work area image. That is, the image display 20 also has a function as an input device of an operator. The image display 20 includes a touch panel, for example.

The image processor 30 performs image processing of the work area images Im1, Im2, and Im3 captured by the imaging device 10 and also performs processing depending on an input operation of the operator on the work area images Im1, Im2, and Im3 displayed by the image display 20. Specifically, the image processor 30 includes a specified-position-coordinate calculator 31, a target detector 32, and a reference-imaging-position determiner 33.

The specified-position-coordinate calculator 31 calculates coordinates of a position specified by the operator as an image of the target T in the work area images Im1, Im2, and Im3 displayed by the image display 20. That is, the specified-position-coordinate calculator 31 obtains coordinates of the position of the target T recognized by the operator on a display screen of the image display 20. In a case where the position recognized by the operator as the target T on the image display 20 is marked with a marker or the like, the specified-position-coordinate calculator 31 obtains coordinates of the position marked with the marker or the like. The coordinates are, for example, two-axis coordinates (X-axis coordinate and Y-axis coordinate) in the work area images Im1, Im2, and Im3. The coordinates may be three-axis coordinates (X-axis coordinate, Y-axis coordinate, and Z-axis coordinate) in the work area.

The target detector 32 detects target images G in the work area images Im1, Im2, and Im3 captured by the imaging device 10. That is, the target detector 32 extracts the target images G from the work area images Im1, Im2, and Im3 through image processing. The method for extracting the target images G by the target detector 32 is similar to a conventional image processing method. Thus, the method for extracting the target images G by the target detector 32 will not be described in detail.

The reference-imaging-position determiner 33 obtains a reference imaging position based on the number of coordinates calculated by the specified-position-coordinate calculator 31 and included in the target images G detected by the target detector 32. That is, the reference-imaging-position determiner 33 obtains the reference imaging position based on the number of matches between images recognized as the target T by the operator in the work area images and target images G extracted by the target detector 32 from the work area images.

Operation of the image processor 30 in a case where the imaging device 10 acquires the work area images Im1, Im2, and Im3 illustrated in FIGS. 3 through 5 will now be described.

In FIGS. 3 through 5, character M denotes a marker provided at a position recognized by the operator as the target on the image display 20. The specified-position-coordinate calculator 31 calculates coordinates of the marker M in the work area images Im1, Im2, and Im3. The coordinates are, for example, two-axis coordinates (X-axis coordinate and Y-axis coordinate) in the work area images Im1, Im2, and Im3. The coordinates may be three-axis coordinates (X-axis coordinate, Y-axis coordinate, and Z-axis coordinate) in the work area.

The target detector 32 detects target images G in the work area images Im1, Im2, and Im3. In FIGS. 3 through 5, target images G detected by the target detector 32 are indicated by bold rectangular frames. The target detector 32 detects target images G based on size of the target images G, sharpness of the target images G, an imaging range (e.g., part, half, all, etc.) of the target T, and so forth in the work area images Im1, Im2, and Im3.

The reference-imaging-position determiner 33 determines the reference imaging position based on the number of coordinates calculated by the specified-position-coordinate calculator 31 and included in the area of the target images G detected by the target detector 32. That is, the reference-imaging-position determiner 33 compares positional relationships between coordinates calculated by the specified-position-coordinate calculator 31 and the target images G detected by the target detector 32 in the work area images Im1, Im2, and Im3, and obtains the number of target images G in each of which the coordinates are included in the area. The reference-imaging-position determiner 33 determines the reference imaging position based on the number of obtained target images G.

With the configuration described above, in performing work on the target T, the image processor 30 can determine the reference imaging position at which the imaging device 10 captures work area images. In addition, the image processor 30 obtains the reference imaging position based on the number of matches between images recognized as the target T by the operator in the work area images and target images G extracted by the target detector 32 from the work area images. Accordingly, the position at which the work area image from which the image processor 30 can appropriately detect target images G is captured can be set as the reference imaging position such that the end effector 53 of the articulated robot arm 50 can efficiently perform work on the target T.

The articulated-robot-arm-control device 1 according to this embodiment includes: the imaging device 10 that is provided at the articulated robot arm 50 and captures work area images, the work area images being images of the work area W where the articulated robot arm 50 performs work on the target T; the image display 20 that displays images captured by the imaging device 10; the image processor 30 that detects an image of the target T from the images captured by the imaging device 10; and the driving controller 40 that drives the actuator of the articulated robot arm 50. The driving controller 40 drives the actuator to thereby move the imaging device 10 to a plurality of imaging positions that are different relative to the work area W. The imaging device 10 captures the work area images at the plurality of imaging positions. The image display 20 displays the plurality of the work area images captured by the imaging device 10 at the plurality of imaging positions. The image processor 30 includes the specified-position-coordinate calculator 31 that calculates coordinates of a position specified by an operator as an image of the target T in at least one work area image of the plurality of work area images displayed by the image display 20, the target detector 32 that detects a target image G that is an image of the target in the plurality of work area images, and the reference-imaging-position determiner 33 that obtains the reference imaging position of the imaging device 10 that captures an image of the work area W in the work, based on the number of target images G in each of which the coordinates are included in an area of the target image G in the plurality of work area images.

The specified-position-coordinate calculator 31 calculates coordinates of the position of the target T specified by the operator in the work area images captured by the imaging device 10 in a work field. The reference-imaging-position determiner 33 calculates the reference imaging position of the imaging device 10 based on the number of target images G in each of which the coordinates are included in the area of the target image G in the target images G detected by the target detector 32 from the work area images. That is, the articulated-robot-arm-control device 1 can obtain an imaging position at which the target T can be appropriately detected with reference to the target T observed by the operator in the work area images reflecting on-site conditions such as brightness or obstacles.

In this manner, the articulated-robot-arm-control device 1 for controlling driving of the articulated robot arm 50 that performs work on the targets T in the work area W can be provided with a configuration enabling the articulated robot arm 50 to efficiently perform work on a larger number of targets T while reducing workload on an operator.

### Second Embodiment

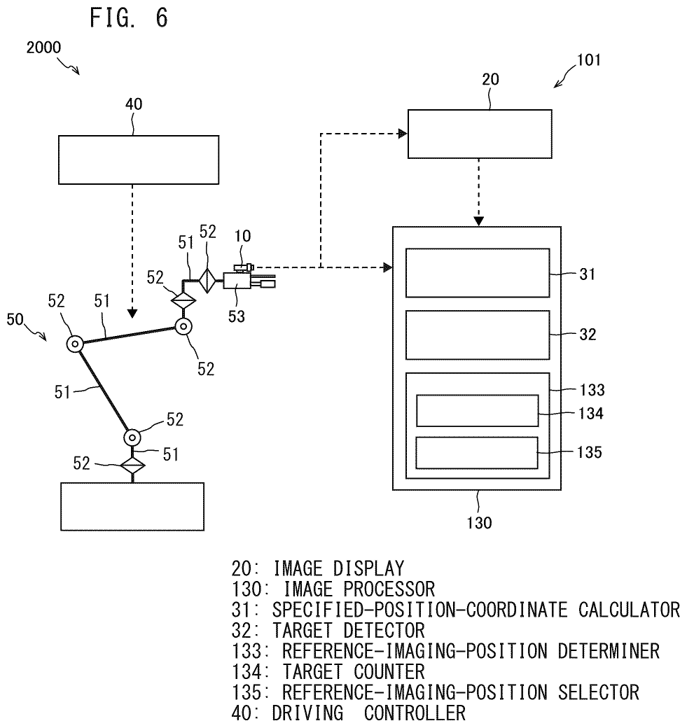

FIG. 6 is a functional block diagram illustrating a schematic configuration of an articulated-robot-arm device 2000 including an articulated-robot-arm-control device 101 according to a second embodiment. As illustrated in FIG. 6, a reference-imaging-position determiner 133 of the articulated-robot-arm-control device 101 according to the second embodiment is different from the articulated-robot-arm-control device 1 according to the first embodiment in selecting one work area image from a plurality of work area images based on the number of target images G in each of which coordinates of a position specified by an operator as an image of a target T are included in the area, and defining an imaging position in the selected one work area image as a reference imaging position. In the following description, components similar to those of the first embodiment are denoted by the same reference characters and will not be described again, and only components different from those of the first embodiment will be described.

As illustrated in FIG. 6, the articulated-robot-arm-control device 101 includes an imaging device 10, an image display 20, and an image processor 130. The image processor 130 includes a specified-position-coordinate calculator 31, a target detector 32, and a reference-imaging-position determiner 133.

The reference-imaging-position determiner 133 selects one work area image from a plurality of work area images based on the number of target images G in each of which coordinates of a position specified by an operator as an image of a target T are included in the region, and sets a position at which the selected one work area image is captured as a reference imaging position. Specifically, the reference-imaging-position determiner 133 selects a work area image including a largest number of target images G in each of which coordinates of the position specified by the operator as images of the target T from the plurality of work area images, and sets an imaging position at which the selected work area image is captured as the reference imaging position.

More specifically, the reference-imaging-position determiner 133 includes a target counter 134 and a reference-imaging-position selector 135.

The target counter 134 counts the number of target images G in each of which coordinates of the position specified by the operator as an image of the target T are included in the region in the plurality of work area images captured by the imaging device 10.

The reference-imaging-position selector 135 selects a work area image including the largest number of target images G counted by the target counter 134, from the plurality of work area images. The reference-imaging-position selector 135 sets an imaging position at which the selected work area image is captured as a reference imaging position.

In the case of examples illustrated in FIGS. 3 through 5 described in the first embodiment, the reference-imaging-position selector 135 selects a second imaging position P2 including a largest number of target images G in the work area images, as a reference imaging position. Thus, in the examples illustrated in FIGS. 3 through 5, the reference imaging position is the second imaging position P2.

In this embodiment, the articulated-robot-arm-control device 101 calculates, as the reference imaging position, an imaging position at which the work area image with a largest number of target images G detected by the image processor 130 in targets T recognized by an operator is captured in the work area images reflecting on-site conditions such as brightness or obstacles. Thus, the work area image captured at the reference imaging position is likely to include a larger number of target images G than work area images captured at other imaging positions. In the work area image captured at the reference imaging position, the number of target images G recognized by the operator is likely to be larger than work area images captured at other imaging positions. Thus, the articulated-robot-arm-control device 101 performs work on targets T by using the work area image captured at the reference imaging position to thereby efficiently perform work on a larger number of targets T.

In this manner, the articulated-robot-arm-control device 101 for controlling driving of the articulated robot arm 50 that performs work on the targets T in the work area W can be provided with a configuration enabling the articulated robot arm 50 to efficiently perform work on a larger number of targets T while reducing workload or an operator.

### Third Embodiment

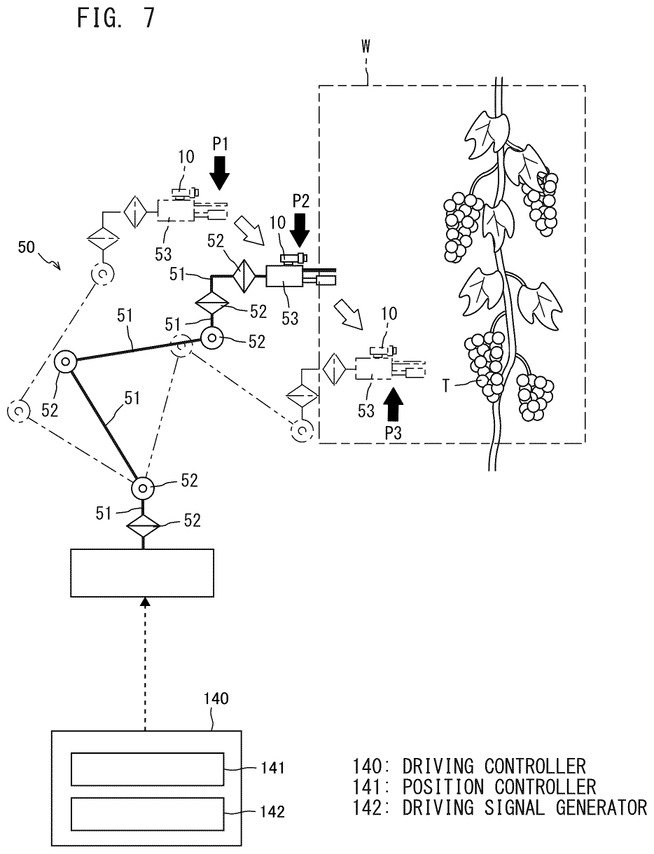

FIG. 7 is a view schematically illustrating a state where driving of an actuator of an articulated robot arm 50 is controlled by using an articulated-robot-arm-control device according to a third embodiment. A driving controller 140 of an articulated-robot-arm-control device according to the third embodiment is different from that of the articulated-robot-arm-control device 1 according to the first embodiment in driving an unillustrated actuator of the articulated robot arm 50 to thereby move an imaging device 10 with predetermined intervals in a direction toward a work area W. In the following description, components similar to those of the first embodiment are denoted by the same reference characters and will not be described again, and only components different from those of the first embodiment will be described.

The articulated-robot-arm-control device includes a driving controller 140 that controls driving of the actuator of the articulated robot arm 50. The configuration of the articulated-robot-arm-control device except the driving controller 140 is similar to the configuration of the articulated-robot-arm-control device 1 according to the first embodiment.

The driving controller 140 controls driving of the articulated robot arm 50 to move the imaging device 10 with predetermined intervals in a direction toward the work area W (i.e., direction of a white arrow in FIG. 7). In the example illustrated in FIG. 7, the imaging device 10 moves in the top-bottom direction as well as in the horizontal direction, but the imaging device 10 may move in the horizontal direction toward a target T in the work area W. That is, the driving controller 140 controls driving of the actuator of the articulated robot arm 50 to move the imaging device 10 in a direction toward the work area W. The driving controller 140 may control driving of the actuator of the articulated robot arm 50 to move the imaging device 10 in a direction away from the work area W.

Specifically, the driving controller 140 includes a position controller 141 and a driving signal generator 142.

The position controller 141 generates and outputs a position instruction signal for determining a position of the imaging device 10 such that the position of the imaging device 10 gradually approaches the work area W. Specifically, the position controller 141 generates and outputs, as the position instruction signal, information on a plurality of imaging positions obtained by dividing the distance between the imaging device 10 and the target T. The position controller 141 may generate the position instruction signal to cause the imaging device 10 to move by a predetermined distance as long as the position of the imaging device 10 relative to the work area W is changeable with predetermined intervals, or may obtain a movement distance by computation such that the imaging device 10 efficiently approaches the work area W and generate the position instruction signal from the result of the obtained movement distance.

In the example illustrated in FIG. 7, the position controller 141 generates and outputs information on a first imaging position P1, a second imaging position P2, and a third imaging position P3, as the position instruction signal. The position instruction signal output from the position controller 141 is input to the driving signal generator 142.

The driving signal generator 142 generates and outputs a driving signal for driving the actuator of the articulated robot arm 50, based on the position instruction signal output from the position controller 141. The driving signal output from the driving signal generator 142 is input to the actuator of the articulated robot arm 50.

In this embodiment, the driving controller 140 drives the actuator to thereby move the imaging device 10 in a direction toward or away from the work area W with predetermined intervals and positions the imaging device 10 at the plurality of imaging positions.

The articulated-robot-arm-control device according to this embodiment changes the position of the imaging device 10 relative to the work area W with predetermined intervals and captures work area images at individual positions. The imaging range of the imaging device 10 and size of images of targets T vary depending on the distance from the imaging device 10 to the work area W.

In a case where the imaging device 10 is moved toward the work area W, for example, the imaging range of the imaging device 10 narrows, whereas images of targets T included in the imaging range enlarge. That is, in the articulated-robot-arm-control device, by moving the imaging device 10 toward the work area W, the detectable number of target images G by the image processor 30 decreases, whereas the possibility of misrecognition of target images G decreases.

On the other hand, in a case where the imaging device 10 moves away from the work area W, the imaging range of the imaging device 10 enlarges, whereas images of targets T included in the imaging range become smaller. That is, in the articulated-robot-arm-control device, by moving the imaging device 10 away from the work area W, the detectable number of target images G by the image processor 30 increases, whereas the possibility of misrecognition of target images G increases.

Thus, the articulated-robot-arm-control device can obtain an optimum imaging position at which both an appropriate detection number and an appropriate recognition rate of target images G can be compatible by adjusting the distance from the work area W to the imaging device 10.

In this manner, the articulated-robot-arm-control device for controlling driving of the articulated robot arm 50 that performs work on the targets T in the work area W can be provided with a configuration enabling the articulated robot arm 50 to efficiently perform work on a larger number of targets T while reducing workload or an operator.

### Fourth Embodiment

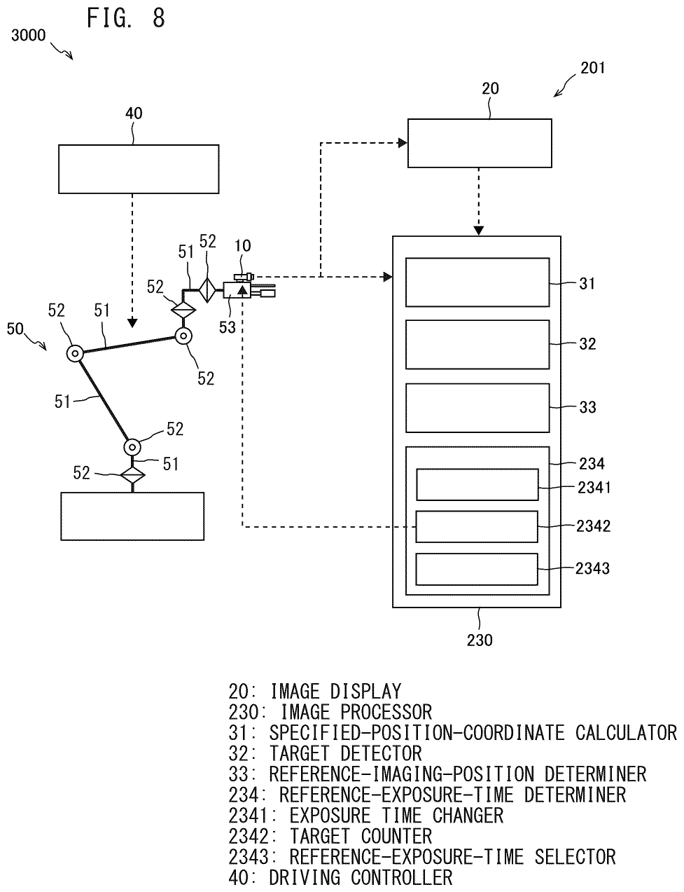

FIG. 8 is a view illustrating a schematic configuration of an articulated-robot-arm device 3000 including an articulated-robot-arm-control device 201 according to a fourth embodiment. The articulated-robot-arm-control device 201 according to the fourth embodiment is different from the articulated-robot-arm-control device 1 according to the first embodiment in that an exposure time of a camera included in an imaging device 10 is determined based on the number of target images G in each of which coordinates of a position specified by an operator as an image of a target T are included in the region of the target image G in a plurality of work area images captured under a plurality of imaging conditions. In the following description, components similar to those of the first embodiment are denoted by the same reference characters and will not be described again, and only components different from those of the first embodiment will be described.

As illustrated in FIG. 8, the articulated-robot-arm-control device 201 includes an image display 20, an image processor 230, and a driving controller 40. The image processor 230 includes a specified-position-coordinate calculator 31, a target detector 32, a reference-imaging-position determiner 33, and a reference-exposure-time determiner 234.

The reference-exposure-time determiner 234 determines a reference exposure time of the camera included in the imaging device 10 by using a plurality of work area images captured under a plurality of imaging conditions at a reference imaging position determined by the reference-imaging-position determiner 33. Specifically, the reference-exposure-time determiner 234 determines the reference exposure time of the camera included in the imaging device 10 based on the number of target images G in each of which coordinates of a position specified by the operator as an image of a target T are included in the area in the plurality of work area images.

The reference-exposure-time determiner 234 includes an exposure time changer 2341, a target counter 2342, and a reference-exposure-time selector 2343.

The exposure time changer 2341 changes an exposure time of the camera included in the imaging device 10. The exposure time changer 2341 generates an instruction signal for changing the exposure time with predetermined time intervals, and outputs the instruction signal to the imaging device 10. Accordingly, the imaging device 10 to which the instruction signal is input can capture a plurality of work area images under a plurality of imaging conditions with various exposure times.

The target counter 2342 counts the number of target images G in each of which coordinates of a position specified by the operator as an image of a target T are included in the area of target image G in the plurality of work area images captured by the imaging device 10.

The reference-exposure-time selector 2343 selects a work area image having a largest number of target images G counted by the target counter 2342 from the plurality of work area images. The reference-exposure-time selector 2343 sets the exposure time of the camera when the selected work area image is captured, as a reference exposure time.

In this embodiment, the articulated-robot-arm-control device 201 captures images of the work area under the plurality of imaging conditions with different exposure times of the camera at the reference imaging position. The articulated-robot-arm-control device 201 determines the exposure time of the camera based on the number of target images G in each of which coordinates of the position of the target image G recognized by the operator are included in the area of the target image G in the plurality of the captured work area images. Accordingly, the articulated-robot-arm-control device 201 can calculate the exposure time of the camera in which the image processor 230 can appropriately detect target images G in the work area images reflecting on-site conditions such as brightness or obstacles.

In this manner, the articulated-robot-arm-control device 201 for controlling driving of the articulated robot arm 50 that performs work on the targets T in the work area W can be provided with a configuration enabling the articulated robot arm 50 to efficiently perform work on a larger number of targets T while reducing workload or an operator.

### Fifth Embodiment

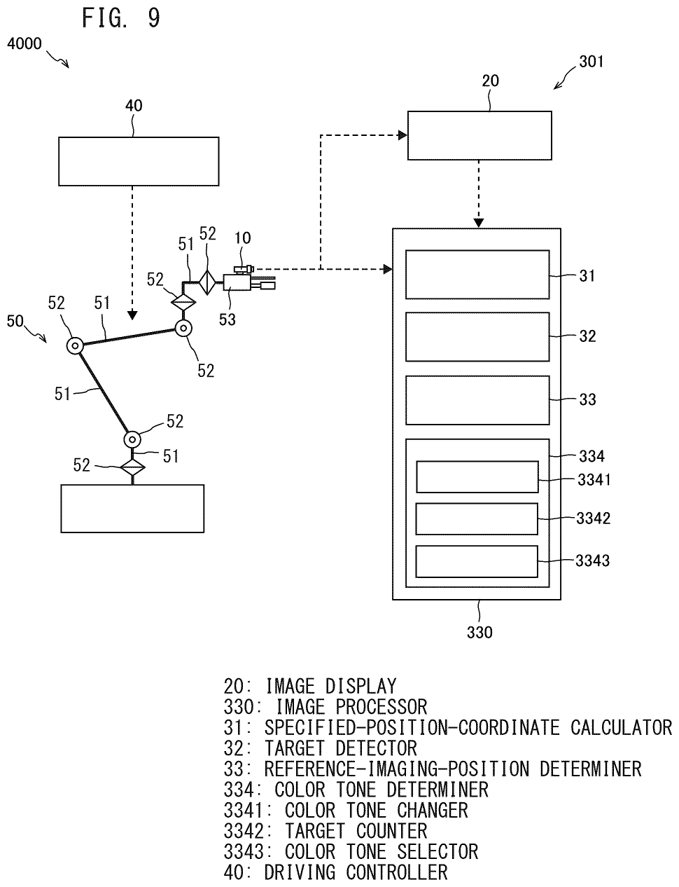

FIG. 9 is a view illustrating a schematic configuration of an articulated-robot-arm device 4000 including an articulated-robot-arm-control device 301 according to a fifth embodiment. The articulated-robot-arm-control device 301 according to the fifth embodiment is different from the articulated-robot-arm-control device 1 according to the first embodiment in determining a color tome of an image captured by an imaging device 10 based on the number of target images G in each of which coordinates of a position specified by an operator as an image of a target T are included in an area in a plurality of work area image captured under a plurality of imaging conditions. In the following description, components similar to those of the first embodiment are denoted by the same reference characters and will not be described again, and only components different from those of the first embodiment will be described.

As illustrated in FIG. 9, the articulated-robot-arm-control device 301 includes an image display 20, an image processor 330, and a driving controller 40. The image processor 330 includes a specified-position-coordinate calculator 31, a target detector 32, a reference-imaging-position determiner 33, and a color tone determiner 334.

The color tone determiner 334 determines a color tone of an image captured by the imaging device 10 by using a plurality of work area images captured under a plurality of imaging conditions at a reference imaging position determined by the reference-imaging-position determiner 33. Specifically, the color tone determiner 334 determines a color tone of an image captured by the imaging device 10 based on the number of target images G in each of which coordinates of a position specified by the operator as an image of the target T are included in the area in the plurality of work area images.

The color tone determiner 334 includes a color tone changer 3341, a target counter 3342, and a color tone selector 3343.

The color tone changer 3341 changes a color tone of an image captured by the imaging device 10. The color tone changer 3341 generates an instruction signal for changing a color tone and outputs the instruction signal to the imaging device 10. Accordingly, the imaging device 10 to which the instruction signal is input can capture a plurality of work area images under a plurality of imaging conditions with various color tones.

The target counter 3342 counts the number of target images G in each of which coordinates of a position specified by the operator as an image of a target T are included in the area of target images G in the plurality of work area images captured by the imaging device 10.

The color tone selector 3343 selects a work area image having a largest number of target images G counted by the target counter 2342 from the plurality of work area images. The color tone selector 3343 adjusts a color tone of an image subjected to image processing or displayed in the articulated-robot-arm-control device 301 to a color tone of the selected work area image.

In this embodiment, the articulated-robot-arm-control device 301 captures images of a work area under a plurality of imaging conditions with different color tones of work area images at the reference imaging position. The articulated-robot-arm-control device 301 determines the color tone of an image based on the number of target images G in each of which coordinates of the position of the target image G recognized by the operator are included in the area of the target image G in the plurality of the captured work area images. Accordingly, the articulated-robot-arm-control device 301 can obtain a color tone with which the image processor 330 can appropriately detect target images G in the work area images reflecting on-site conditions such as brightness or obstacles.

In this manner, the articulated-robot-arm-control device 301 for controlling driving of the articulated robot arm 50 that performs work on the targets T in the work area W can be provided with a configuration enabling the articulated robot arm 50 to efficiently perform work on a larger number of targets T while reducing workload or an operator.

### Other Embodiments

The embodiments of the present teaching have been described above, but the embodiments are merely examples for carrying out the present teaching. Thus, the present teaching is not limited to the embodiments described above, and the embodiments may be modified as necessary within a range not departing from the gist of the present teaching.

In the embodiments, the image display 20 includes a display device of a portable terminal capable of being carried by the operator, such as a liquid crystal display. Alternatively, the image display may be included in an articulated arm robot, or may be included in a device other than the articulated arm robot. The image display may be located at any position as long as the image display can display work area images acquired by the imaging device and an operator can make an input to the image display.

In the embodiments, the plurality of imaging positions of the imaging device 10 are three imaging positions. Alternatively, the plurality of imaging positions may include two imaging positions or four or more imaging positions.

In the first embodiment, the reference-imaging-position determiner 33 of the image processor 30 obtains the reference imaging position of the imaging device 10 at which the work area is captured during work, based on the number of target images in each of which coordinates of the position specified by the operator as an image of the target are included in the area in the target images detected by the target detector 32 in the plurality of work area images. The reference-imaging-position determiner may select one work area image from the plurality of work area images based on the number of target images in each of which the coordinates are included in the area in the plurality of work area images, and set an imaging position at which the selected one work area image is captured, as the reference imaging position. The reference-imaging-position determiner may set an imaging position different from the imaging positions at which the plurality of work area images are captured, as the reference imaging position, based on the number of target images in each of which the coordinates are included in the area in the plurality of work area images.

In the second embodiment, the reference-imaging-position selector 135 selects the work area image having a largest number of target images counted by the target counter 134 from the plurality of work area images and sets the imaging position at which the selected work area image is captured, as the reference imaging position. Alternatively, the reference-imaging-position selector may obtain the reference imaging position based on the number of target images counted by the target counter. For example, the reference-imaging-position selector may estimate an imaging position at which the number of target images counted by the target counter is largest by using the number of target images in the plurality of work area images, and may set the estimated imaging position as the reference imaging position.

In the second embodiment, the reference-imaging-position selector may obtain a ratio between the number of target images detected by the target detector and the number of target images counted by the target counter in the plurality of work area images captured by the imaging device, select one work area image from the plurality of work area images based on the ratio, and set the imaging position at which the selected one work area image is captured as the reference imaging position. That is, the reference-imaging-position determiner may obtain the reference imaging position based on the ratio between the number of the target images in the plurality of work area images and the number of target images in each of which the coordinates are included in the area of the target image.

The reference-imaging-position selector with the configuration described above selects the work area image having a highest ratio of target images counted by the target counter to the number of target images detected by the target detector 32 from the plurality of work area images, and sets the imaging position at which the work area image is captured as the reference imaging position.

The articulated-robot-arm-control device with the configuration described above calculates the reference imaging position of the work area from the ratio between the number of targets recognized by the operator and the number of targets detected by the image processor in the work area images reflecting on-site conditions such as brightness or obstacles. Accordingly, the articulated-robot-arm-control device can set, as the reference imaging position, the imaging position at which the ratio of detecting images of targets visually recognized by the operator is higher than that in work area images captured at other imaging positions.

In the second embodiment, the target counter may count the number of target images in each of which coordinates of the position specified by the operator as an image of the target are out of the area in a plurality of work area images captured by the imaging device. In this case, the reference-imaging-position selector selects the work area image with a smallest number of target images counted by the target counter from the plurality of work area images and sets the imaging position at which the selected work area image is captured, as the reference imaging position.

That is, the reference-imaging-position determiner of the articulated-robot-arm-control device with the configuration described above may select the work area image with the smallest number of the target images in each of which coordinates of the position specified by the operator as the image of the target are out of the area from the plurality of work area images, and set the imaging position at which the selected work area image is captured, as the reference imaging position.

In the case of the examples illustrated in FIGS. 3 through 5, the target counter counts the number of target images G in each of which the marker M is out of the area of the target image G detected by the target detector in the work area images Im1, Im2, and Im3. The reference-imaging-position selector selects, as the reference imaging position, the second imaging position P2 that is an imaging position of the work area image Im2 with a smallest number of counts by the target counter in the work area images Im1, Im2, and Im3. In this manner, the reference-imaging-position determiner determines the second imaging position P2 as the reference imaging position.

The articulated-robot-arm-control device with the configuration described above calculates, as the reference imaging position, the imaging position at which the work area image with a smallest number of targets recognized by the operator and undetected by the image processor is captured in work area images reflecting on-site conditions such as brightness or obstacles. Thus, in the work area image captured at the reference imaging position, the number of target images difficult to be detected by the image processor is likely to be smaller than work area images captured at other imaging positions. In addition, in the work area image captured at the reference imaging position, the possibility of reduction of misdetection of target images visually recognized by the operator is high, as compared to work area images captured at other imaging positions. Accordingly, the articulated-robot-arm-control device performs work on targets by using the work area image captured at the reference imaging position to thereby efficiently perform work on a larger number of targets.

In the third embodiment, the driving controller 140 drives the unillustrated actuator of the articulated robot arm 50 to thereby move the imaging device 10 with predetermined intervals in the direction toward the work area W. Alternatively, the driving controller may move the imaging device laterally relative to the work area with predetermined intervals by driving the actuator to thereby position the imaging device at a plurality of imaging positions. The driving controller may move the imaging position of the imaging device in any direction relative to the work area such that the number of targets in work area images captured by the imaging device varies.

In the third embodiment, the position controller 141 generates and outputs information on the first imaging position P1, the second imaging position P2, and the third imaging position P3 as the position instruction signal. Alternatively, the position controller may generate and output information on two imaging positions as the position instruction signal, or may generate and output information on four or more imaging positions as the position instruction signal.

In the fourth embodiment, the reference-exposure-time selector 2343 selects the work area image having a largest number of target images G counted by the target counter 2342 from the plurality of work area images, and sets an exposure time of the camera when the selected work area image is captured, as the reference exposure time. Alternatively, the reference-exposure-time selector may set, as the reference exposure time, a time other than the exposure time of the camera when a plurality of work area images are captured, based on the number of target images counted by the target counter.

In the fifth embodiment, the color tone selector 3343 selects the work area image having a largest number of target images G counted by the target counter 2342 from the plurality of work area images, and sets the color tone of the selected work area image as the color tone of the image. Alternatively, the color tone selector may set a color tone other than the color tone of a plurality of work area images as the color tome of the image, based on the number of target images G counted by the target counter.

### DESCRIPTION OF REFERENCE CHARACTERS

1, 101, 201, 301 articulated-robot-arm-control device
10 imaging device
20 image display
30, 130, 230, 330 image processor
31 specified-position-coordinate calculator
32 target detector
33, 133 reference-imaging-position determiner
40, 140 driving controller
50 articulated robot arm
51 arm
5 52 joint part
53 end effector
134, 2342, 3342 target counter
135 reference-imaging-position selector
141 position controller
10 142 driving signal generator
1000, 2000, 3000, 4000 articulated-robot-arm device
T target
G target image
W work area

1. An articulated-robot-arm-control device for controlling an articulated robot arm performing work on at least one target object in a work area, the articulated-robot-arm-control device comprising:
an imaging device including a camera, provided at the articulated robot arm and configured to capture a plurality of work area images, each of which is an image of the work area, respectively at a plurality of imaging positions that are different from one another relative to the work area;
an image display that displays the plurality of work area images captured by the imaging device;
an image processor that determines a reference imaging position that is a position of the imaging device; and
a driving controller that drives an actuator of the articulated robot arm, to thereby move the imaging device to the plurality of imaging positions, wherein
the image processor includes:
a specified-position-coordinate calculator that, in response to an operator of the articulated-robot-arm-control device specifying each of the target objects appearing in at least one work area image of the plurality of work area images displayed by the image display, calculates a set of coordinates corresponding to a position of said each specified target object,
a target detector that detects a plurality of target images, each of which is an image of one of the target objects, in the plurality of work area images, and
a reference-imaging-position determiner that
determines a subset of the target images in each of the plurality of work area images, each target image in the subset having at least one of the calculated sets of coordinates within a boundary thereof,
determines a total number of the target images in said subset for said each work area image, and
determines the reference imaging position based on the total numbers of the target images for the plurality of work area images.

2. The articulated-robot-arm-control device according to claim 1, wherein
the reference-imaging-position determiner selects one work area image from the plurality of work area images based on the total numbers of the target images for the plurality of work area images, and sets an imaging position at which the imaging device captures the selected one work area image as the reference imaging position.

3. The articulated-robot-arm-control device according to claim 1, wherein
the reference-imaging-position determiner selects one of the work area images that has a largest total number of the target images, and sets an imaging position at which the imaging device captures the selected work area image as the reference imaging position.

4. The articulated-robot-arm-control device according to claim 1, wherein
the reference-imaging-position determiner selects one of the work area images that has a smallest total number of the target images, and sets an imaging position at which the imaging device captures the selected work area image as the reference imaging position.

5. The articulated-robot-arm-control device according to claim 1, wherein
the reference-imaging-position determiner obtains the reference imaging position based on a ratio between a total number of the target images detected by the target detector and the total number of the target images for each of the plurality of work area images.

6. The articulated-robot-arm-control device according to claim 1, wherein
the driving controller moves the imaging device relative to the work area with predetermined intervals by driving the actuator to thereby position the imaging device at the plurality of imaging positions.

7. The articulated-robot-arm-control device according to claim 1, wherein
the imaging device includes the camera configured to capture a second plurality of work area images at the reference imaging position respectively with a plurality of different exposure times of the camera, and
the image processor further includes a reference-exposure-time determiner that determines a reference exposure time of the camera based on the second plurality of work area images.

8. The articulated-robot-arm-control device according to claim 1, wherein
the imaging device captures a second plurality of work area images at the reference imaging position respectively with a plurality of different color tones, and
the image processor further includes a color tone determiner that determines a reference color tone based on the second plurality of work area images.
